(19) United States
(12) Patent Application Publication
(10) Pub. No.: US 2011/0137748 A1
(43) Pub. Date: Jun. 9, 2011

(54) Systems and Methods for Virtual Credit Card Transactions

(76) Inventor: Yigal Baher, Brooklyn, NY (US)

(21) Appl. No.: 12/634,655

(22) Filed: Dec. 9, 2009

(51) Int. Cl. G06Q 20/00; G06Q 30/00; G06F 15/16

(52) U.S. Cl. 705/26.41; 705/44; 709/219

(57) ABSTRACT

The present invention is directed to methods and devices for secure virtual credit card transactions. In one embodiment, a consumer system initiates a transaction with a merchant system. The consumer system generates a first verification code and a second verification code. The consumer system provides the merchant system with the first verification code. The merchant system transmits the first verification code to an authorizing entity, and the consumer system independently transmits the second verification code to the authorizing entity. The authorizing entity compares the verification codes received from both the consumer system and the merchant system. Based on the results of the comparison, the authorizing entity either approves or rejects the transaction.

### BACKGROUND

The present application is directed to systems and methods for credit card transactions between a consumer and a merchant and, more particularly, for systems and methods for secure credit card transactions in which a permanent credit card account number of the consumer is not revealed to the merchant during the transaction.

Credit card use has become pervasive in all areas of commerce. According to the U.S. Census Bureau, there are approximately 180 million credit cardholders in the United States. The annual credit card volume in the United States alone is approaching $3 trillion dollars annually. The average American owns four credit cards, and 14 percent of Americans own more than 10 credit cards.

As credit card use has increased, so has the theft of credit card information. Losses due to credit card theft are in the billions of dollars each year. With the increasing amount of purchases made over the Internet, the opportunity for credit card theft will only increase. As an Internet transaction is processed, the credit card information may reside for some period of time on multiple computer systems and be transmitted several times between those systems. Each transmission and each computer storage media presents an opportunity for thieves to hack into the computer system and steal the credit card information.

The credit card industry has developed numerous security standards such as PCI DSS to thwart credit card theft from computer systems. Regardless of the measures taken to protect the stored credit card information, the possibility will always exist that unauthorized access to the information will occur.

### SUMMARY

The present invention is directed to methods and devices for secure virtual credit card transactions. In one embodiment, a consumer system may initiate a transaction with a merchant system. The consumer system may generate a first verification code and a second verification code, each of which may be comprised of an alphanumeric string. The consumer system may provide the merchant system with the first verification code. The merchant system may transmit the first verification code to an authorizing entity, and the consumer system may independently transmit the second verification code to the authorizing entity. The authorizing entity may compare the verification codes received from both the consumer system and the merchant system. Based on the results of the comparison, the authorizing entity may either approve or reject the transaction.

### BRIEF DESCRIPTION OF THE DRAWINGS

FIG. 1 is a diagram of a network environment according to one embodiment.

FIG. 2 is an illustration of the general flow of information within a network environment according to one embodiment.

FIG. 3 is a flow diagram of a secure mode of a virtual credit card application according to one environment.

FIG. 4 is a flow diagram of a manual mode of a virtual credit card application according to one environment.

FIG. 5 illustrates the syntax of a seller transaction code according to one embodiment.

FIG. 6 illustrates the syntax of a consumer sales order number according to one embodiment.

FIG. 7 illustrates the syntax of a temporary uniform resource locator according to one embodiment.

### DETAILED DESCRIPTION

The present application is directed to methods and devices for secure virtual credit card transactions. In one embodiment, a consumer system initiates a transaction with a merchant system. The consumer system generates a first verification code and a second verification code, each of which may be comprised of an alphanumeric string. In one embodiment, the first and second verification codes may each be comprised of a randomly generated number of a predetermined length. The consumer system provides the merchant system with the first verification code. The merchant system transmits the first verification code to an authorizing entity, and the consumer system independently transmits the second verification code to the authorizing entity. The authorizing entity compares the first and second verification codes received from the merchant system and the consumer system, respectively. Based on the results of the comparison, the authorizing entity either approves or rejects the transaction. In one embodiment, the authorizing entity approves the transaction if the first verification code received from the consumer system is identical to the second verification code received from the merchant system. Otherwise, the authorizing entity may reject the transaction.

In the description that follows, a number of terms are used. In order to provide a clear and consistent understanding of the specification and appended claims, including the scope to be given such terms, the following definitions are provided:

ACK—Acknowledgement. An acknowledge signal sent between systems, can indicate success or failure.

CSON—Consumer Sales Order Number. An alphanumeric string generated by the credit card application software and used by the credit card company to verify a transaction between a consumer and a merchant.

CC—Credit Card. A credit account established by an authorizing bank with a cardholder. The credit account allows the cardholder (consumer) to undertake a transaction with a merchant. The authorizing bank issues funds to the merchant in the amount of the transaction. The cardholder is then obligated to repay the authorizing bank the amount of the transaction and, in some cases, interest or fees. The term “credit card” may refer to a physical card presented by the cardholder to the merchant, or to a virtual credit card (see definition below).

CCA—Credit Card Application. A software application functional to emulate a credit card account in a transaction between a consumer and a merchant without disclosing a credit card number to the merchant.

CC Number—Credit Card Number. An alphanumeric string used to uniquely identify a credit card account associated with a consumer.

Device ID—Device Identification Number. An alphanumeric string used to uniquely identify a particular electronic device used by a consumer to complete a transaction with a merchant.

MAC Address—Media Access Control Address. A unique number assigned to each piece of network hardware by the manufacturer. The MAC address allows each network device to be uniquely identified on a network so that data intended for that device can be properly delivered to the intended device.

PDA—Personal Digital Assistant. A (typically) handheld device with some or all of the functionality of a laptop or desktop computer, including wired and/or wireless communications.

RFID—Radio Frequency Identification. The use of a device that transmits radio waves for identification.

SSL—Secure Socket Layer. An encryption protocol that allows secure communications over a network.

STC—Seller Transaction Code. An alphanumeric string generated by a merchant to uniquely identify a particular transaction with a particular consumer.

tempURL—Temporary Uniform Resource Locator. A temporary Internet address generated by a merchant and for use by a credit card application to deliver a consumer sales order number to the merchant.

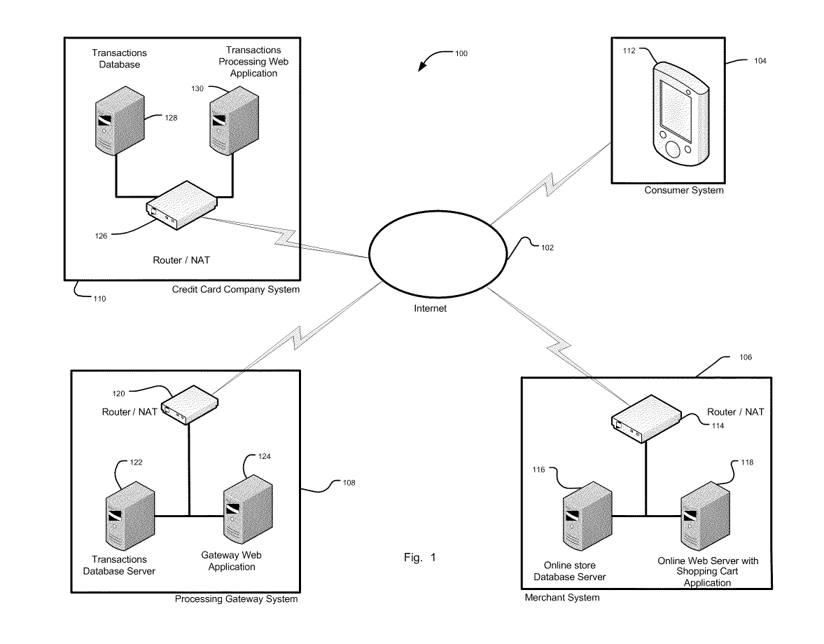

FIG. 1 is a simplified block diagram of a network environment 100 that may illustrate one embodiment of the present invention. Although this figure depicts objects as functionally separate, such depiction is merely for illustrative purposes. It will be apparent to those skilled in the art that the objects portrayed in this figure may be arbitrarily combined or divided into separate software, firmware, or hardware components. Furthermore, it will also be apparent to those skilled in the art that such components, regardless of how they are combined or divided, can execute on the same computer or can be arbitrarily distributed among different computers which may be connected by one or more networks.

As illustrated in FIG. 1, network environment 100 comprises a plurality of computer or data processing systems coupled to a communications network 102. The systems illustrated in FIG. 1 include a consumer system 104, a merchant system 106, a processing gateway system 108, and a credit card company system 110. Communications network 102 provides a mechanism for allowing communication between the various systems depicted in FIG. 1. Communications network 102 may be a local area network (LAN), a wide area network (WAN), a wireless network, an intranet, the Internet, a private network, a public network, or any other suitable communications network. Communications network 102 may comprise many interconnected computer systems and communication links. The communication links may be hard wire links, optical links, satellite or other wireless communication links, wave propagation links, or any other mechanism for communication of information. Various communication protocols may be used to facilitate communication of information via the communication links, including TCP/IP, HTTP, HTTPS, and IPsec protocols, extensible markup language (XML), wireless application protocol (WAP), protocols under development by industry standards organizations, vendor-specific protocols, customized protocols, and others as known by those skilled in the art.

Consumer system 104 may represent a mobile or stationary communications device 112 such as a personal digital assistant (PDA), cell phone, smart phone, personal computer, laptop computer or the like. The communications device 112 may run on an operating system such as Windows, Windows Mobile, MacOS, iPhone OS, SunOS, Linux, Unix, or any other operating system for mobile or stationary computers and communications devices. The communications device 112 may run a credit card application (CCA) that allows the use of a credit card to pay for a transaction between a consumer and a merchant. The application may also facilitate communication between the consumer system 104 and any other system connected to the communications network 102. Additionally, the communications device may include a display area for visually displaying information.

Merchant system 106 may represent a system of a merchant and may be located online (e.g., on the Internet) or at a physical storefront. The merchant system 106 may comprise a routing device 114. It is to be understood that data conveyed between the various systems of FIG. 1 may traverse a plurality of routing devices 114 on their way between source and destination sites. The mechanisms for data transfer over the Internet (or other communication link) are well known and not described in great detail here. It is understood that data are transferred as packets according one or more protocols, such as the Transmission Control Protocol/Internet Protocol (TCP/IP), and the routing device 114 facilitates the transfer of data packets back and forth between the systems illustrated in FIG. 1.

Merchant system 106 may also comprise a database server 116 and an online web server 118. The web server 118 may deliver content, such as one or more web pages, to another computer on the communications network 102 (e.g., the consumer system communication device 112). The content may be delivered using Hypertext Transfer Protocol (HTTP) or another protocol. The web pages may comprise a home page for the merchant, an inventory listing of products and/or services offered by the merchant, and a shopping cart function to facilitate purchase of the products or services. As used herein, web server 118 comprises hardware, operating system, web server software, TCP/IP protocols, and site content, either collectively or individually.

The merchant system 106 database server 116 may provide database services to the web server 118. Database services may include inventory control of products and services, orders received through the web server 118, order details, such as name and address of consumer, and other information specific to the operation of the particular merchant. As used herein, database server 116 comprises hardware, operating system, database software, TCP/IP protocols, and database content, either collectively or individually.

It is understood that router 114, database server 116, and web server 118 may be comprised of and reside on individual computers, a plurality of computers, or a single computer without departing from the scope of the present invention.

Processing gateway system 108 may represent a system that enables the merchant system to authorize and process credit card transactions. The merchant system obtains credit card account information from the consumer system, which may occur through the merchant system 106. The credit card account information may be passed to the processing gateway system 108. The processing gateway system 108 may submit the transaction to a credit card network comprising a plurality of financial institutions that manage the processing, clearing, and settlement of credit card transactions. These financial institutions that manage credit card transactions are referred to herein as an authorizing entity. The authorizing entity may be comprised of the financial institution that issued the consumer's credit card, or may be comprised of more than one financial institution. The transaction may then be routed to the credit card company system 110 of the issuing bank for the consumer's credit card which approves or denies the transaction. The approval/denial decision may be routed by the credit card network back to the issuing bank. Assuming the credit card company system 110 authorizes the credit card transaction, the approval may be routed through the credit card network back to the merchant system 106 for completion of the transaction. Note that for simplicity of explanation here, FIG. 1 does not explicitly illustrate the credit card network. However, in one embodiment, the credit card network is included within credit card company system 110.

Both the processing gateway system 108 and the credit card company system 110 may comprise a router 120, 126 which functions similarly to the router 114 described above for the merchant system 106. The processing gateway system 108 may further comprise a transactions database server 122 and a gateway web application server 124. The transactions database server 122 may maintain records of each transaction processed as well as information on each merchant and other database information. The gateway web application server 124 may provide secure communications through communication network 102, and contain one or more application programs that control operation of the processing gateway system 108. The router 120, transactions database server 122, and gateway web application server 124 may be comprised of and reside on individual computers, a plurality of computers, or a single computer without departing from the scope of the present invention.

The credit card company system 110 may further comprise a transactions database server 128 and transactions processing web application server 130. The transactions database server 128 may maintain account records for each consumer's account, transaction records, and other database information. The transactions processing web application server 130 may provide secure communications through communication network 102, and contain one or more application programs that control operation of the credit card company system. The router 126, transaction database server 128, and transactions processing web application server 130 may be comprised of and reside on individual computers, a plurality of computers, or a single computer without departing from the scope of the present invention.

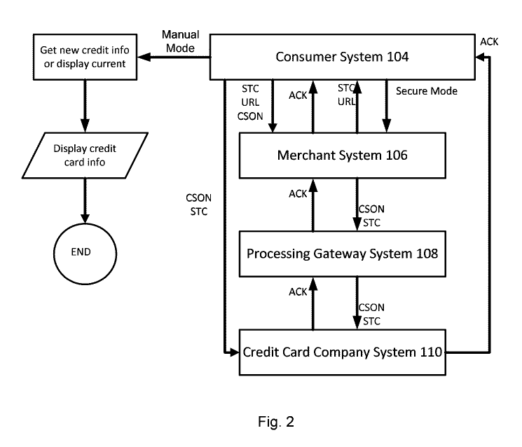

FIG. 2 illustrates a general flow of information between the various systems depicted in FIG. 1 according to one embodiment. The consumer, utilizing communications device 112 initiates a transaction with the merchant. The transaction may occur in either a secure mode or a manual mode. In general, a transaction in secure mode is a web-based transaction involving the consumer accessing the merchant system 106 via the communications network 102. A manual mode transaction is typically used when the consumer is interacting with the merchant other than over the Internet, such as when the consumer is at the merchant's physical storefront, or the transaction is being carried out by voice over the telephone.

For a secure transaction, the merchant system 106 notifies consumer system 104 of a secure mode transaction. The merchant system 106 then sends a seller transaction code (STC) and a temporary URL address to the consumer system 104 with an acknowledgement of the transaction. The consumer system 104 generates a first verification code and submits the first verification code back to the merchant system 106 using the temporary URL. The consumer system 104 also includes the STC so that the merchant system 106 can properly identify the consumer system 104. The consumer system 104 also sends the STC and a second verification code to the credit card company system 110. The first or second verification code may be comprised of a consumer sales order number (CSON). The CSON is described in more detail below.

The merchant system 106, independent of the consumer system 104, sends the STC and CSON to the processing gateway system 108, which in turn sends the STC and CSON to the credit card company. The credit card company issues and acknowledgement back to the consumer system 104 and processing gateway system 108. The processing gateway system 108 relays the acknowledgement to the merchant system 106.

In manual mode, the consumer system 104 obtains current credit card information from memory or other storage medium and displays the information for use by the merchant in the transaction. Alternately, the consumer system 104 may obtain new credit card information from the credit card company system, which may then be displayed for use by the merchant in the transaction.

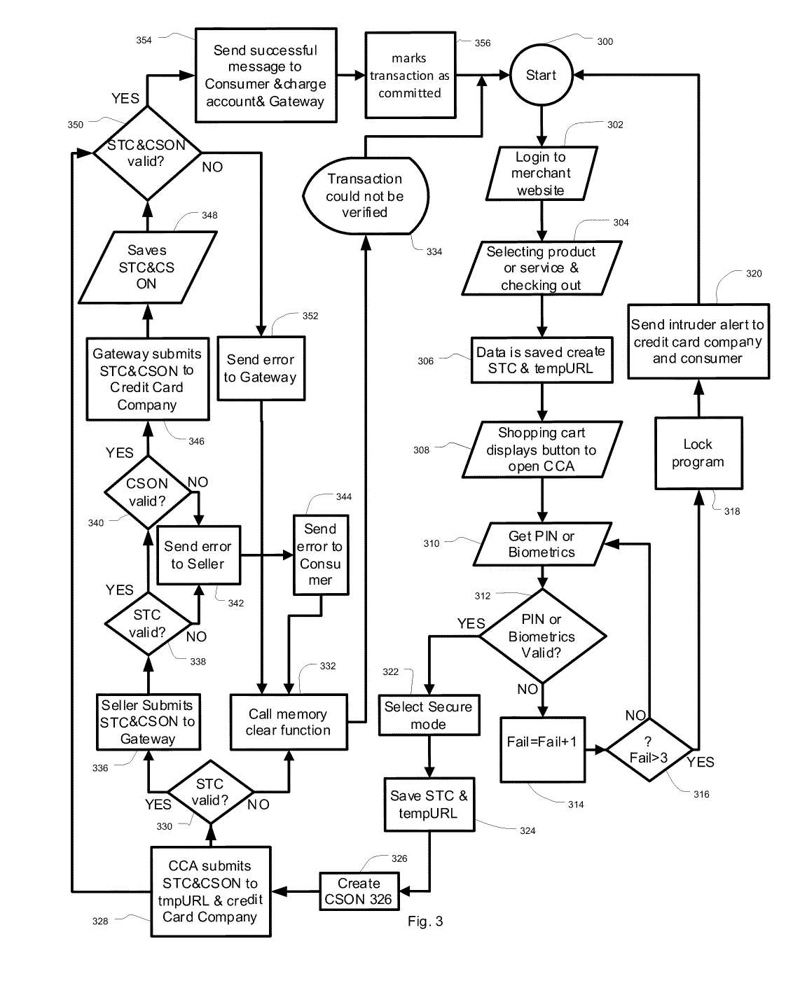

FIG. 3 is a high level flowchart describing the steps of processing a secure credit card transaction according to one embodiment of the CCA. Using communications device 112, the consumer initiates a transaction (step 300) and logs into the merchant's website (step 302) resident on the online web server 118. The consumer browses the website and selects products to purchase by placing the products or services into a shopping cart (step 304). The merchant system 106 stores the consumer's shopping cart information on online store database server 116 and generates a STC and temporary URL specific to this transaction (step 306). Within the online store database server 116, information is stored to associate this particular purchase by the consumer with the STC and temporary URL (see step 324 below). The shopping cart function of the merchant's website displays payment options for the consumer to select, one of which is the CCA (step 308).

Once the consumer selects the CCA, a prompt is displayed on the communications device 112 to enter identification information such as a personal identification number (PIN) or biometric data (step 310). Successful entry of identification information may be required in order to open and use the CCA. The PIN may be an alphanumeric string, a word or phrase, a barcode or the like as is known in the art. The biometric data may be a fingerprint, voice print, skin pH, retinal scan, facial recognition, or the like as in known in the art. The CCA then verifies the identification information against reference data stored in memory (step 312). If the identification information validation fails, then a counter is started (step 314) and the value of the counter is compared to a predetermined value (step 316). As illustrated in FIG. 3, the predetermined value is three. Thus, the consumer has three chances to correctly enter the identification information. Although a maximum counter value of three is used here, any number of validation attempts could be used, including one. If the value of the counter is below the predetermined value, then control returns to step 310 for the next entry of the identification information. If the maximum number of entries of the identification information is reached, then the CCA locks the use of the communications device 112 from further transactions (step 318) and a notification of a potential intruder is sent to the consumer and the credit card company system 110 (step 320). The lockout may be for a predetermined period of time (e.g., one hour) or may require resetting by another entity (e.g., the credit card company system 110).

If the identification information is validated at step 312, then the CCA prompts the consumer to select secure or manual mode (step 322). If secure mode is selected, the CCA stores the STC and temporary URL in memory on the communications device 112 (or another storage device associated with the communications device 112) (step 324). At step 328, the CCA then generates one or more consumer sales order numbers (CSON) (e.g., verification codes), each of which may be a unique alphanumeric string that will be used for security purposes during later validation of the transaction as described below.

The CCA then accesses the merchant system 106 using the temporary URL and submits the STC and a first CSON to the merchant system 106 (step 328). The CCA independently submits the STC and a second CSON to the credit card company system 110 (step 328) via the communications device 112. The merchant system 106 checks the STC received via the temporary URL against the STC stored in the database server 116 for that temporary URL (step 330). If the received STC does not match the stored STC, then the merchant system 106 notifies the CCA of the failure. The CCA clears the memory of the communications device 112 for this transaction (e.g., deletes the STC and temporary URL) (step 332) and displays an error message on the display of the communications device 112 (step 334).

If the STC verification passes, then the merchant system 106 submits the STC and the first CSON to the processing gateway system 108 (step 336). The processing gateway then checks the validity of the STC and the first CSON (steps 338 and 340). If the processing gateway system 108 verification fails, then an error message is sent to the merchant system 106 (step 342) and may also be displayed on the communications device 112 (step 344). If the processing gateway system 108 verification passes, then the gateway processing system 108 submits the STC and the first CSON to the credit card company system 110 (step 346).

The credit card company system 110 stores the STC and the first CSON on the transactions database server 128 (step 348). The credit card company system 110 retrieves from the transactions database server 128 the first CSON received from the merchant system 106 and the second CSON received from the CCA via the consumer system 104, which are indexed in the database by the common STC. The credit card company system 110 (e.g., authorizing entity) then performs a comparison of the first and second CSON (step 350). Based on the results of the comparison, the credit card company system 110 will either approve the transaction and send a message to the consumer system 104 and the processing gateway (step 354), or deny the transaction and send an error message to both the processing gateway system 108 (step 352) and to consumer system 104 (step 344), and clear the memory of consumer system 104 (step 332). If the transaction is approved, the credit card company system may additionally charge the credit card account of the consumer (step 354) and mark the transaction as committed (step 356).

In one embodiment, the comparison of the first and second CSON performed by the credit card company system 110 at step 350 is a check of whether the first and second CSON are identical. The transaction may be approved if the first and second CSON are identical, and denied otherwise. However, other embodiments may rely on a different comparison. For example, as an added layer of security, either or both of the CCA and the processing gateway system 108 may encrypt the first and second CSON in a manner known by the credit card company system 110, such as AES or SSL encryption. Other alterations of the first and second CSON may also be performed as is known in the art, such appending the CSON with a check code. Thus, in the case of one or both of the first and second CSON being modified prior to receipt by the credit card company system 110, the comparison may be other than a check for identical values.

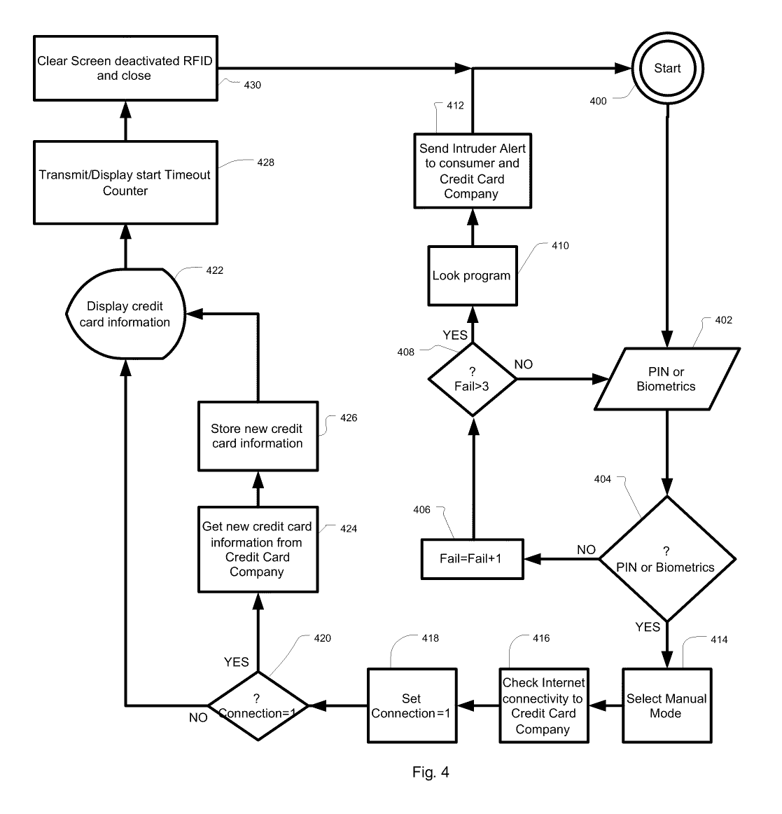

FIG. 4 is a high level flowchart describing the steps of processing a manual mode transaction according to one embodiment. Using communications device 112, the consumer initiates a transaction (step 400) by activating the CCA. The CCA then prompts the consumer to enter identification information such as a PIN or biometric data (step 402). Successful entry of identification information may be required in order to open and use the CCA. The PIN may be an alphanumeric string, a word or phrase, a barcode or the like as is known in the art. The biometric data may be a fingerprint, voice print, skin pH, retinal scan, facial recognition, or the like as in known in the art. The CCA then verifies the identification information against reference data stored in memory (step 404). If the identification information validation fails, then a counter is started (step 406) and the value of the counter is compared to a predetermined value (step 408). As illustrated in FIG. 4, the predetermined value is three. Thus, the consumer has three chances to correctly enter the identification information. Although a maximum counter value of three is used here, any number of validation attempts could be used, including one. If the value of the counter is below the predetermined value, then control returns to step 402 for the next entry of the identification information. If the maximum number of entries of the identification information is reached, then the CCA locks the use of the communications device 112 from further transactions (step 410) and a notification of a potential intruder is sent to the consumer and the credit card company system 110 (step 412). The lockout may be for a predetermined period of time (e.g., one hour) or may require resetting by another entity (e.g., the credit card company system 110).

If the identification information is validated at step 404, then the CCA prompts the consumer to select secure or manual mode (step 414). If manual mode is selected, the CCA checks for Internet connectivity (step 416). If Internet connectivity has been established, a variable for the connection state is set to a value of one (step 418); otherwise, the variable is zero. The value of the connection state is then checked (step 420). If the connection state is zero, indicating that the communications device 112 is not currently connected to the Internet, then the CCA retrieves from memory the last credit card information established by the CCA and displays the information on the communications device 112 (step 422). If the connection state is one, indicating that the communications device 112 is currently connected to the Internet, then the CCA contacts the credit card company system 110 and requests a limited use (e.g., a one-time use) credit card number (step 424). The CCA stores the limited use credit card information (credit card number, expiration date, cardholder's name, credit limit, etc.) in the memory of the communications device 112 (step 426) and then displays the information on the communications device 112 (step 422). The displayed information may be in the form of an alphanumeric string which the merchant may enter into a point of sale terminal, a barcode which may be scanned by the merchant, or other such display as is known in the art.

In one embodiment, the communications device 112 includes functionality to allow transmittal of the credit card information over a relatively short distance to the merchant. Such functionality may include a radio frequency identification (RFID) transmitter, an infrared transmitter, a Bluetooth transmitter, or other transmitter as is known in the art. The communications device 112 may then transmit the credit card information directly to the merchant's point of sale terminal and avoid displaying the information where a third party may see it.

The CCA may include a timer function that limits the amount of time the credit card information is displayed or the short range communication is functional. The CCA may start the timer (step 428) and then clear the display or terminate the short range communication functionality after a predetermined period of time (step 430).

To maintain security of the consumer's credit card account, the manual mode may make use of a temporary, limited use credit card number. The credit card company system 110 upon request by the CCA, generates a credit card number different than a permanent credit card number associated with the consumer's account. This limited use credit card number may be valid for a single use or for a predetermined period of time (e.g., one hour or one day). The credit card company system 110 may maintain a database of which permanent credit card account number is associated with each limited use credit card number in the transactions database server 128.

In one embodiment, after the transaction is complete, the CCA contacts the credit card company system 110 and notifies the credit card company system 110 that the limited use credit card number has been used. In the case of a single-use temporary credit card number, the CCA sends a request to the credit card company system 110 that the single-use credit card number be deactivated from further use.

As is apparent in both the secure mode and manual mode descriptions above, the consumer's permanent credit card number may not be revealed to the merchant during the transaction. In the secure mode, the merchant is given the STC and the CSON, but these values may be valid for only a single transaction and only when verified through a comparison of similar information submitted to the credit card company system 110 through the processing gateway system 108. In the manual mode, the merchant is given a limited use credit card number, not the permanent credit card account number. Thus, in addition to providing verifiable data for the credit card company system 110 to process a valid transaction, the present invention provides security to the consumer since the permanent credit card account information is not stored in the communications device 112. Additionally, a third party in possession of the communications device 112 may not access the permanent credit card account information.

As illustrated in FIG. 5, the STC may be an alphanumeric string having a length of 1024 bits. In one embodiment, the string may be comprised of a variety of substrings. The Merchant ID substring uniquely identifies the merchant. The Transaction ID substring is a random value that unique identifies each transaction. Additionally, the STC may be comprised of substrings indicating the time and date of the transaction and the total dollar amount of the transaction. In one embodiment, the STC may also include a Cyclic Redundancy Check (CRC) error detection code to check for errors after transmitting the STC over the communications network 102. The CRC may be based on any error detection algorithm as is known in the art. In one embodiment, the STC may have a length other than 1024 bits and may contain more or less information than illustrated in FIG. 5.

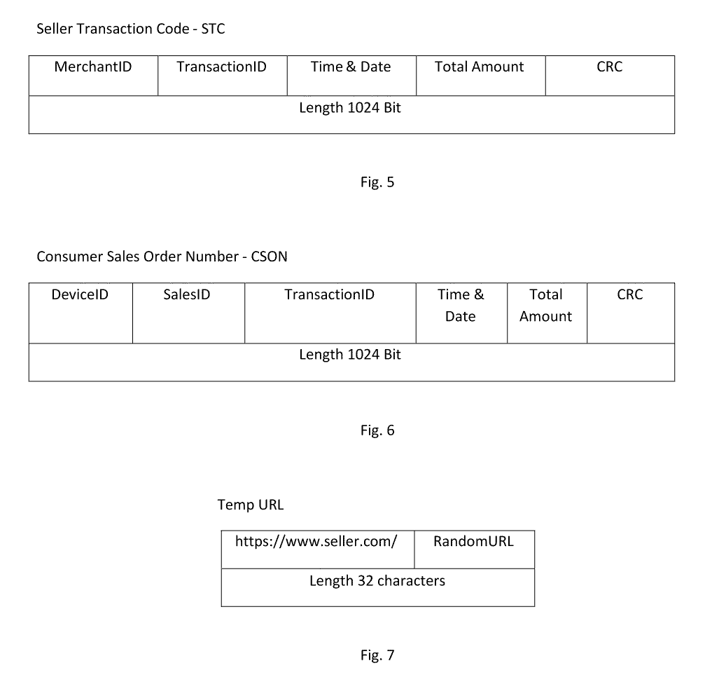

FIG. 6 illustrates one embodiment of the alphanumeric string that comprises the CSON. The CSON may have a length of 1024 bits and may be comprised on a variety of substrings. The Device ID substring uniquely identifies a particular communications device 112. In one embodiment, the Device ID substring is comprised of a combination of the MAC address of the communications device 112 and the consumer's permanent credit card account number. The Sales ID substring may be generated by the consumer system 104 to identify a sales order number. The Transaction ID substring is a random value that unique identifies each transaction and may be the same as the transaction ID in the STC (see FIG. 5). Similar to the STC, the CSON may also be comprised of substrings indicating the time and date of the transaction, the total dollar amount of the transaction, and a CRC error detection code to check for errors after transmitting the STC over the communications network 102.

FIG. 7 illustrates one embodiment of the temporary URL generated by the merchant system 106. The temporary URL may be comprised of the host name for the merchant's online web site (e.g., IP address, fully qualified domain name) followed by an alphanumeric string or prefixed by a subdomain. In one embodiment, the alphanumeric string has a length of 32 characters. The subdomain may be a randomly generated URL and may have a length of 32 alphanumeric characters. As is known in the art, the temporary URL may be comprised of more or less subdomains having lengths other than 32 alphanumeric characters. In other embodiments, the temporary URL may be comprised of any IP addresses, domain names, alphanumeric characters, etc. as is known in the art to provide a desired level of security.

In one embodiment of the present invention, the CCA is downloaded from a host site by the consumer and stored in memory of the communications device 112. The host site may be the credit card company system 110 and may be accessible over communications network 102. In one embodiment, the consumer enrolls in the service through the credit card company (or other authorized entity) and the credit card company issues a communications device 112 to the consumer.

One embodiment may be implemented using a conventional general purpose or a specialized digital computer or microprocessor programmed according to the teachings of the present disclosure, as will be apparent to those skilled in the computer art. Appropriate software coding can be readily prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium having instructions stored thereon which can be used to program a computer to perform any of the features presented herein. The storage medium may include, but is not limited to, any type of disk including floppy disks, optical discs, DVD, CD-ROMs, microdrive, magneto-optical disks, ROMs, RAMs, EPROMs, EEPROMs, DRAMs, VRAMs, flash memory devices, magnetic or optical cards, nanosystems (including molecular memory ICs), or any other type of media or device suitable for storing instructions and/or data.

Stored on any one or more of the computer readable media, the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for performing a secure transaction between a consumer and a merchant, comprising:
sending via a communications device of the consumer to a computer system of the merchant a signal to initiate the transaction;
sending via the communications device of the consumer to the computer system of the merchant a first verification code, wherein the computer system of the merchant transmits the first verification code to an authorizing entity;
sending via the communications device of the consumer to the authorizing entity a second verification code, wherein the authorizing entity compares the first and second verification codes;
receiving from the authorizing entity an approval or denial of the transaction based on a result of the comparison.

2. The method of claim 1, wherein the first and the second verification codes are identical.

3. The method of claim 1, wherein the authorizing entity comparing the first and second verification codes further comprises determining whether the first and second verification codes are identical.

4. The method of claim 1, wherein sending via the communications device of the consumer comprises sending via a cell phone of the consumer.

5. The method of claim 1, wherein the first verification code comprises one or more of an alphanumeric string to identify the communications device of the consumer, an alphanumeric string to identify a sales order number, and an alphanumeric string to identify the transaction.

6. The method of claim 1, wherein the second verification code comprises one or more of an alphanumeric string to identify the communications device of the consumer, an alphanumeric string to identify a sales order number, and an alphanumeric string to identify the transaction.

7. The method of claim 1, further comprising:
after sending via the communications device of the consumer to the computer system of the merchant the signal to initiate the transaction, accessing the computer system of the merchant and selecting one or more products or services to purchase; and
receiving from the computer system of the merchant a temporary Internet address and using the temporary Internet address to send the first verification code to the computer system of the merchant.

8. The method of claim 7, wherein accessing the computer system of the merchant comprises accessing a web server.

9. A method of performing a secure transaction between a consumer and a merchant, comprising:
receiving from a computer system of the merchant a first verification code;
receiving from a communications device of the consumer a second verification code;
comparing the first and second verification codes;
sending an approval or denial of the transaction to either or both of the computer system of the merchant and the communications device of the consumer based on a result of the comparison.

10. The method of claim 9, wherein the first and the second verification codes are identical.

11. The method of claim 9, wherein comparing the first and second verification codes further comprises determining whether the first and second verification codes are identical and approving the transaction if the first and second verification codes are identical.

12. A system for performing a secure transaction between a consumer and a merchant, comprising:
a communications device of the consumer configured to generate and transmit first and second verification codes;
a computer system of a merchant configured to receive the first verification code and subsequently transmit the first verification code; and
a computer system of an authorizing entity configured to receive the first verification code from the computer system of the merchant and receive the second verification code from the communications device of the consumer;
wherein the computer system of the authorizing entity compares the first and second verification codes and transmits an approval or denial of the transaction to one or both of the communications device of the consumer and the computer system of the merchant based on a result of the comparison.

13. The method of claim 12, wherein the first and the second verification codes are identical.

14. The method of claim 12, wherein comparing the first and second verification codes further comprises determining whether the first and second verification codes are identical and approving the transaction if the first and second verification codes are identical.

15. A machine readable medium having instructions stored thereon that when executed by a processor cause a system to:
send via a communications device of a consumer to a computer system of a merchant a signal to initiate a transaction;
send via the communications device of the consumer to the computer system of the merchant a first verification code, wherein the computer system of the merchant transmits the first verification code to an authorizing entity;
send via the communications device of the consumer to the authorizing entity a second verification code, wherein the authorizing entity compares the first and second verification codes;
receive from the authorizing entity an approval or denial of the transaction based on a result of the comparison.

16. The machine readable medium of claim 15, wherein the authorizing entity compares the first and second verification codes further comprises determining whether the first and second verification codes are identical and approving the transaction if the first and second verification codes are identical.

17. A method for performing a secure transaction between a consumer and a merchant, comprising:
accessing a computer system of an authorizing entity and further accessing a credit card account of the consumer stored on the computer system of the authorizing entity;
requesting a temporary credit card number from the computer system of the authorizing entity, wherein the temporary credit card number is associated with the credit card account of the consumer;
receiving the temporary credit card number on a communications device of the consumer; and
relaying the temporary credit card number to the merchant.

18. The method of claim 17, further comprising after relaying the temporary credit card number to the merchant, accessing the computer system of the authorizing entity and requesting that the temporary credit card number be deactivated.

19. The method of claim 17, wherein relaying the temporary credit card number to the merchant further comprises establishing a communications link between the communications device of the consumer and a computer system of the merchant using radio waves and transmitting the temporary credit card number from the communications device of the consumer to the computer system of the merchant on the communications link.

20. The method of claim 17, wherein relaying the temporary credit card number to the merchant further comprises displaying the temporary credit card number on a display screen of the communications device of the consumer.
